(19) United States
(12) Patent Application Publication
(10) Pub. No.: US 2025/0046511 A1
(43) Pub. Date: Feb. 6, 2025

(54) COIL ELECTRONIC COMPONENT

(71) Applicant: SAMSUNG ELECTRO-MECHANICS CO., LTD., Suwon-si (KR)

(72) Inventors: Dong Jin Lee, Suwon-si (KR); Donghwan Lee, Suwon-si (KR); Soonkwang Kwon, Suwon-si (KR); Tae Hyun Kim, Suwon-si (KR); Byeongcheol Moon, Suwon-si (KR); Boumseock Kim, Suwon-si (KR)

(73) Assignee: SAMSUNG ELECTRO-MECHANICS CO., LTD., Suwon-si (KR)

(21) Appl. No.: 18/768,869

(22) Filed: Jul. 10, 2024

(30) Foreign Application Priority Data
Aug. 2, 2023 (KR) 10-2023-0101099

(51) Int. Cl. H01F 27/28; H01F 5/04; H01F 27/29

(52) U.S. Cl. CPC H01F 27/2828; H01F 5/04; H01F 27/292

(57) ABSTRACT

A coil electronic component includes: a main body including a first surface and a second surface facing each other, and including a magnetic material; a coil including at least one turn of a conductive wire, at least a portion of which being embedded in the main body; a first external electrode connected to a first lead-out portion of the coil; and a second external electrode connected to a second lead-out portion of the coil, wherein a cross-sectional shape of the coil is a triangular shape.

### CROSS-REFERENCE TO RELATED APPLICATION

This application claims priority to and the benefit of Korean Patent Application No. 10-2023-0101099 filed in the Korean Intellectual Property Office on Aug. 2, 2023, the entire contents of which are incorporated herein by reference.

### BACKGROUND

### Technical Field

The present disclosure relates to a coil electronic component.

### Description of the Related Art

Recently, as the functions of mobile devices diversify, power consumption increases, and in order to increase battery usage time in mobile devices, passive components with low loss and excellent efficiency are employed around a power management integrated circuit (PMIC).

Inductors used to stabilize the power of mobile devices may be divided into a stacked type, a thin film type, and a wire-wound type based on how the coils are formed. During the manufacturing process of the wire-wound inductor, a stage for pressing a sheet made of a magnetic material onto a coil is performed, and during this process, the coil may be deformed or pushed due to high pressure, which may deteriorate the characteristics of the inductor.

### SUMMARY

The present disclosure attempts to provide a coil electronic component that is capable of preventing a coil from deforming during a manufacturing process.

However, the objective of the present disclosure is not limited to the aforementioned one, and may be extended in various ways within the spirit and scope of the present disclosure.

An embodiment of the present disclosure provides a coil electronic component including: a main body including a first surface and a second surface facing each other, and including a magnetic material; a coil including a first lead-out portion, a second lead-out portion, and at least one turn of a conductive wire, wherein a cross-sectional shape of the conductive wire includes a triangular shape, and at least a portion of the coil is embedded in the main body; a first external electrode connected to the first lead-out portion; and a second external electrode connected to the second lead-out portion.

The coil may include a first portion including the at least one turn of the conductive wire, and a second portion connected to the first portion and including the at least one turn of the conductive wire, the conductive wire in the first portion may be disposed such that one side of a triangular cross-section of the conductive wire in the first portion faces the first surface, and the conductive wire in the second portion may be disposed such that one side of the triangular cross-section of the conductive wire in the second portion faces the second surface.

The triangular cross-section of the conductive wire in the first portion and the triangular cross-section of the conductive wire in the second portion may be alternately disposed such that the triangular cross-section of the conductive wire in the second portion is inverted relative to the triangular cross-section of the conductive wire in the first portion.

Each of two outermost turns of the conductive wire in the first portion may have the triangular cross-section, and each of two outermost turns of the conductive wire in the second portion may have the triangular cross-section that is inverted relative to the triangular cross-section of the two outermost turns of the conductive wire in the first portion.

The magnetic material may include metal magnetic particles, and the metal magnetic particles may include two or more types of powders with different compositions.

The metal magnetic particles may include iron (Fe).

The coil electronic component may further include an insulation film on a surface of the conductive wire.

The coil electronic component may further include an insulation layer on a surface of the main body except for a portion where the first lead-out portion is connected to the first external electrode and a portion where the second lead-out portion is connected to the second external electrode.

Another embodiment of the present disclosure provides a coil electronic component including: a main body including a magnetic material; a first coil including at least one turn of a first conductive wire, at least a portion of the first coil being embedded in the main body; and a second coil spaced apart from the first coil, including at least one turn of a second conductive wire, at least a portion of the second coil being embedded in the main body, wherein a cross-sectional shape of the first conductive wire includes a triangular shape and a cross-sectional shape of the second conductive wire includes a triangular shape. The first coil and the second coil may be edgewise coils.

The main body may include a core around which the first coil and the second coil are wound in common.

The first coil may include a first portion including the at least one turn of the first conductive wire and a second portion connected to the first portion and including the at least one turn of the first conductive wire, the first conductive wire in the first portion may be disposed such that one side of a triangular cross-section of the first conductive wire in the first portion faces the core, and the first conductive wire in the second portion may be disposed such that one side of the triangular cross-section of the first conductive wire in the second portion faces an external surface of the main body.

The second coil may include a third portion including the at least one turn of the second conductive wire and a fourth portion connected to the third portion and including the at least one turn of the second conductive wire, the second conductive wire in the third portion may be disposed such that one side of a triangular cross-section of the second conductive wire in the third portion faces the core, and the second conductive wire in the fourth portion may be disposed such that one side of the triangular cross-section of the second conductive wire in the fourth portion faces an external surface of the main body.

A number of turns of the first coil and a number of turns of the second coil may be the same.

A number of turns of the first coil and a number of turns of the second coil may be different.

Another embodiment of the present disclosure provides a coil electronic component including: a main body including a magnetic material; and at least one coil including a conductive wire having a triangular cross-section, the at least one coil includes a first portion including at least one turn of the conductive wire, and a second portion connected to the first portion and including at least one turn of the conductive wire, wherein the triangular cross-section of the conductive wire in the first portion and the triangular cross-section of the conductive wire in the second portion are alternately disposed, wherein the triangular cross-section of the conductive wire in the second portion is inverted relative to the triangular cross-section of the conductive wire in the first portion, and wherein at least a portion of the coil is embedded in the main body.

The coil electronic component may further include: a first external electrode; and a second external electrode, wherein the at least one coil may further include: a first lead-out portion connected to the first external electrode, and a second lead-out portion connected to the second external electrode.

The at least one coil may include a first coil and a second coil, and the first coil and the second coil are edgewise coils.

According to the coil electronic component according to the embodiment, by making the cross-sectional shape of the coil a triangular shape, the coil may be prevented from deforming during the process for manufacturing the coil electronic component.

### BRIEF DESCRIPTION OF THE DRAWINGS

FIG. 1 shows a perspective view of a coil electronic component according to an embodiment.

FIG. 2 shows a cross-sectional view taken along line II-II′ in FIG. 1.

FIG. 3A, FIG. 3B, FIG. 3C, and FIG. 3D show various cross-sectional shapes of a coil.

FIG. 4 shows a cross-sectional view of a coil electronic component according to another embodiment.

FIG. 5 shows a perspective view of a coil electronic component according to another embodiment.

FIG. 6 shows a bottom perspective view of the coil electronic component in FIG. 5.

FIG. 7 shows a cross-sectional view taken along line VII-VII′ in FIG. 5.

### DETAILED DESCRIPTION

In the following detailed description, only certain embodiments of the present disclosure have been shown and described, simply by way of illustration. The drawings and description are to be regarded as illustrative in nature and not restrictive. Like reference numerals designate like elements throughout the specification. Some constituent elements are exaggerated, omitted, or briefly illustrated in the added drawings, and sizes of the respective constituent elements do not reflect the actual sizes.

The accompanying drawings are provided only in order to allow embodiments disclosed in the present specification to be easily understood and are not to be interpreted as limiting the spirit disclosed in the present specification, and it is to be understood that the present disclosure includes all modifications, equivalents, and substitutions without departing from the scope and spirit of the present disclosure.

Terms including ordinal numbers such as first, second, and the like will be used only to describe various constituent elements, and are not to be interpreted as limiting these constituent elements. The terms are only used to differentiate one constituent element from other constituent elements.

It will be understood that when an element such as a layer, film, region, or substrate is referred to as being “on” another element, it can be directly on the other element or intervening elements may also be present. In contrast, when an element is referred to as being “directly on” another element, there are no intervening elements present. The word “on” or “above” means disposed on or below the object portion, and does not necessarily mean disposed on the upper side of the object portion based on a gravitational direction.

It should be understood that the term “include”, “comprise”, “have”, or “configure” indicates that a feature, a number, a step, an operation, a constituent element, a part, or a combination thereof described in the specification is present, but does not exclude a possibility of presence or addition of one or more other features, numbers, steps, operations, constituent elements, parts, or combinations, in advance. Unless explicitly described to the contrary, the word “comprise” and variations such as “comprises” or “comprising” will be understood to imply the inclusion of stated elements but not the exclusion of any other elements.

The phrase “in a plan view” or “on a plane” means viewing a target portion from the top, and the phrase “in a cross-sectional view” or “on a cross-section” means viewing a cross-section formed by perpendicularly cutting a target portion from the side.

Throughout the specification, when it is described that a part is “connected” to another part, the part may be “directly connected” to the other element, may be “connected” to the other part through a third part, or may be connected to the other part physically or electrically, and may be referred to by different titles depending on dispositions or functions, but respective portions that are substantially integrated into one body may be connected to each other.

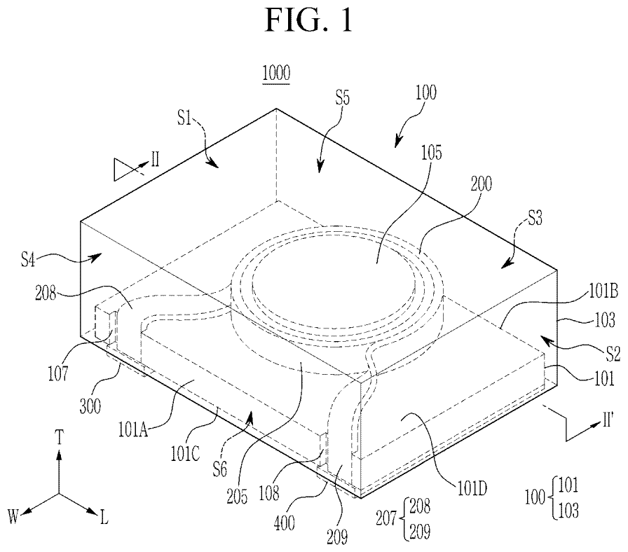

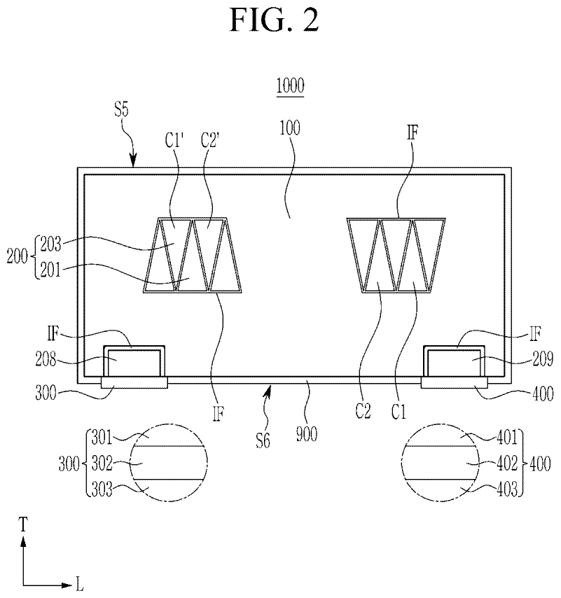

FIG. 1 shows a perspective view of a coil electronic component according to an embodiment, and FIG. 2 shows a cross-sectional view taken along line II-II′ in FIG. 1.

Referring to FIG. 1 and FIG. 2, the coil electronic component 1000 may include a main body 100, a coil 200, a first external electrode 300, and a second external electrode 400.

The main body 100 may have a substantially hexahedral shape, but the present embodiment is not limited thereto. Due to shrinkage during sintering, the main body 100 may have a substantially hexahedral shape, although not a perfect hexahedral shape. For example, the main body 100 has a substantially rectangular parallelepiped shape, but corner or vertex portions may have a round shape.

In the present embodiment, for convenience of description, two surfaces facing each other in a length direction (L-axis direction) are defined as a first surface S1 and a second surface S2, respectively, two surfaces facing each other in a width direction (W-axis direction) are defined as a third surface S3 and a fourth surface S4, respectively, and two surfaces facing each other in a thickness direction (T-axis direction) are defined as a fifth surface S5 and a sixth surface S6, respectively.

A length of the coil electronic component 1000 may mean, based on an optical microscope or scanning electron microscope (SEM) photograph of a cross-section taken in the length direction (L-axis direction)-the thickness direction (T-axis direction) at a center of the coil electronic component 1000 in the width direction (W-axis direction), a maximum value of lengths of a plurality of line segments that connect two outermost boundary lines facing each other in the length direction (L-axis direction) of the coil electronic component 1000 shown in the above cross-sectional photograph and are parallel to the length direction (L-axis direction). Alternatively, the length of the coil electronic component 1000 may mean a minimum value of lengths of a plurality of line segments that connect two outermost boundary lines facing each other in the length direction (L-axis direction) of the coil electronic component 1000 shown in the above-mentioned cross-sectional photograph and are parallel to the length direction (L-axis direction), respectively. Alternatively, the length of the coil electronic component 1000 may mean an arithmetic average value of lengths of at least two of line segments that connect two outermost boundary lines facing each other in the length direction (L-axis direction) of the coil electronic component 1000 shown in the above cross-sectional photograph and are parallel to the length direction (L-axis direction).

A thickness of the coil electronic component 1000 may mean, based on an optical microscope or scanning electron microscope (SEM) photograph of a cross-section taken in the length direction (L-axis direction)-the thickness direction (T-axis direction) at a center of the coil electronic component 1000 in the width direction (W-axis direction), a maximum value of lengths of a plurality of line segments that connect two outermost boundary lines facing each other in the thickness direction (T-axis direction) of the coil electronic component 1000 shown in the above cross-sectional photograph and are parallel to the thickness direction (T-axis direction). Alternatively, the thickness of the coil electronic component 1000 may mean a minimum value of lengths of a plurality of line segments that connect two outermost boundary lines facing each other in the thickness direction (T-axis direction) of the coil electronic component 1000 shown in the above-mentioned cross-sectional photograph and are parallel to the thickness direction (T-axis direction), respectively. Alternatively, the thickness of the coil electronic component 1000 may mean an arithmetic average value of lengths of at least two line segments among a plurality of line segments that connect two outermost boundary lines facing each other in the thickness direction (T-axis direction) of the coil electronic component 1000 shown in the above-mentioned cross-sectional photograph and parallel to the thickness direction (T-axis direction), respectively.

A width of the coil electronic component 1000 may mean, based on an optical microscope or scanning electron microscope (SEM) photograph of a cross-section taken in the length direction (L-axis direction)-the width direction (W-axis direction) at a center of the coil electronic component 1000 in the thickness direction (T-axis direction), a maximum value of lengths of a plurality of line segments that connect two outermost boundary lines facing each other in the width direction (W-axis direction) of the coil electronic component 1000 shown in the above cross-sectional photograph and are parallel to the width direction (W-axis direction). Alternatively, the width of the coil electronic component 1000 may mean a minimum value of lengths of a plurality of line segments that connect two outermost boundary lines facing each other in the width direction (W-axis direction) of the coil electronic component 1000 shown in the above-mentioned cross-sectional photograph and are parallel to the width direction (W-axis direction), respectively. On the other hand, the width of the coil electronic component 1000 may mean an arithmetic average value of lengths of at least two of line segments that connect two outermost boundary lines facing each other in the width direction (W-axis direction) of the coil electronic component 1000 shown in the above-mentioned cross-sectional photograph and are parallel to the width direction (W-axis direction), respectively.

Meanwhile, each of the length, the width, and the thickness of the coil electronic component 1000 may be measured using a micrometer measurement method. In the micrometer measurement method, a zero point is set with a micrometer providing gage repeatability and reproducibility (Gage R&R), the coil electronic component 1000 according to the present embodiment is inserted between tips of the micrometer, and a measuring lever of the micrometer is turned for the measurement. Meanwhile, when measuring the length of the coil electronic component 1000 by the micrometer measurement method, the length of the coil electronic component 1000 may mean a value measured once or mean an arithmetic average of values measured a plurality of times. This may be equally applied to measuring of the width and the thickness of the coil electronic component 1000.

The main body 100 constitutes an exterior of the coil electronic component 1000, and has a space where a magnetic path, which is a path through which the magnetic flux induced by the coil 200 passes, is formed, when a current is applied to the coil 200 through the first external electrode 300 and the second external electrode 400.

The main body 100 surrounds and encapsulates the coil 200, and includes a magnetic material. The main body 100 includes magnetic particles, and an insulation material may be interposed between the magnetic particles.

The magnetic material may include a first metal magnetic powder, a second metal magnetic powder having a particle size larger than that of the first metal magnetic powder, and a third metal magnetic powder having a particle size larger than that of the second metal magnetic powder. The average particle diameter D₅₀ of the first metal magnetic powder may be 0.1 μm or more and 0.2 μm or less, the average particle diameter D₅₀ of the second metal magnetic powder may be 1 μm or more and 2 μm or less, and the average particle diameter D₅₀ the third metal magnetic powder may be 25 μm or more and 30 μm or less.

The magnetic particles may be ferrite particles or metal magnetic particles that exhibit magnetic properties.

The ferrite particles may include, for example, at least one of spinel-type ferrites such as Mg—Zn-based ferrites, Mn—Zn-based ferrites, Mn—Mg-based ferrites, Cu—Zn-based ferrites, Mg—Mn—Sr-based ferrites, Ni—Zn-based ferrites, hexagonal ferrites such as Ba—Zn-based ferrites, Ba—Mg-based ferrites, Ba—Ni-based ferrites, Ba—Co-based ferrites, Ba—Ni—Co-based ferrites, garnet-type ferrites such as Y-based ferrites, and Li-based ferrites.

The metal magnetic particles may include two or more types of powder particles having different compositions, and may include one or more selected from the group consisting of iron (Fe), silicon (Si), chromium (Cr), cobalt (Co), molybdenum (Mo), aluminum (Al), niobium (Nb), copper (Cu), and nickel (Ni). For example, metal magnetic particles may include one or more of pure iron, an Fe—Si-based alloy, an Fe—Si—Al-based alloy, an Fe—Ni-based alloy, an Fe—Ni—Mo-based alloy, an Fe—Ni—Mo—Cu-based alloy, an Fe—Co-based alloy, an Fe—Ni—Co-based alloy, an Fe—Cr-based alloy, an Fe—Cr—Si-based alloy, an Fe—Si—Cu—Nb-based alloy, an Fe—Ni—Cr-based alloy, and an Fe—Cr—Al-based alloy. Here, different compositions of the metal magnetic particles may mean different contents.

The metal magnetic particles may be amorphous or crystalline. For example, the metal magnetic particles may be an Fe—Si—B—Cr-based amorphous alloy, but the present embodiment is not limited thereto. The metal magnetic particles may have an average particle diameter of about 0.1 μm to 30 μm, but are not limited thereto. In this specification, the average particle diameter may refer to a particle size distribution expressed as D₉₀, D₅₀, or the like. The particle size distribution is well known to those skilled in the art an indicator of what proportion of particles of what size (particle diameter) are contained within a population of particles to be measured. D₅₀ (a particle diameter corresponding to 50% of a cumulative volume of the particle size distribution) refers to an average particle diameter.

The metal magnetic particles may be two or more types of different metal magnetic particles. Here, that the types of the metal magnetic particles are different means that the metal magnetic particles are distinguished from each other in at least one of an average particle diameter, composition, component ratio, crystallinity, and shape.

The insulating material may include epoxy, polyimide, liquid crystal polymer, etc. alone or in combination, but is not limited thereto.

The main body 100 includes a base portion 101 and a cover portion 103. The base portion 101 may include a protrusion portion 105.

The base portion 101 may include a front surface 101A and a rear surface 101B facing each other in the width direction (W-axis direction), and a lower surface 101C and an upper surface 101D facing each other in the thickness direction (T-axis direction). The lower surface 101C of the base portion 101 may comprise the sixth surface S6 of the main body 100.

The protrusion portion 105 may be disposed on the upper surface 101D of the base portion 101, and the protrusion portion 105 may be integral with the base portion 101. A shape of the protrusion portion 105 viewed in the thickness direction (T-axis direction) is not particularly limited, and may be a circle, an ellipse, a triangle, a rectangle, or any other shape. The protrusion portion 105 may have various known shapes that can be accommodated in a hollow space of the coil 200. That is, the protrusion portion 105 may be a core of the coil 200.

The base portion 101 may be formed by filling a mold with a magnetic material. The base portion 101 may also be formed by filling a mold with a composite material including a magnetic material and an insulating resin.

The cover portion 103 may be disposed on an upper side of the base portion 101 and may surround all surfaces of the base portion 101 except for the lower surface 101C. Therefore, the cover portion 103 may comprise the first surface S1, the second surface S2, the third surface S3, the fourth surface S4, and the fifth surface S5 of the main body 100, and the base portion 101 and the cover portion 103 may together comprise the sixth surface S6 of the main body 100. At least one of the base portion 101 and the cover portion 103 may include a magnetic material, and may comprise magnetic particles and an insulating resin interposed between the magnetic particles.

The method for forming the main body 100 is not particularly limited. For example, the main body 100 may be formed by placing magnetic sheets on the upper and lower portions of the coil 200 and then compressing and curing the magnetic sheets. In another example, a magnetic powder may be filled to surround the coil 200 and portions of the first external electrode 300 and the second external electrode 400, and then subjected to a pressing and curing process by a mold to form the main body 100.

The coil 200 is embedded in the main body 100, exhibiting the characteristics of the coil electronic component 1000. For example, when the coil electronic component 1000 of the present embodiment is used as a power inductor, and a current is applied to the coil 200, the coil 200 may serve to stabilize power source of an electronic device by storing energy as a magnetic field.

The coil 200 may have a shape in which a metal (e.g., copper (Cu) or silver (Ag)) wire coated with an insulating material is spirally wound. That is, the coil 200 may be a wound coil. The coil 200 is not limited to a single wire, and may comprise a stranded wire or two or more wires.

The coil 200 may be an air coil, wound around the protrusion portion 105 of the base portion 101. The coil 200 may be a circular coil but is not limited thereto. For example, the coil 200 may be a variety of well-known coils such as a rectangular coil.

The coil 200 includes a first portion 201 and a second portion 203, and the second portion 203 is connected to the first portion 201.

The first portion 201 and the second portion 203 may have a plurality of turns.

For example, the first portion 201 may have an outermost turn coil C1 and an innermost turn coil C2 sequentially from an external surface toward an internal side of the main body 100. Meanwhile, although not shown, at least one intermediate turn coil may be disposed between the outermost turn coil C1 and the innermost turn coil C2.

Likewise, the second portion 203 may have an outermost turn coil C1′ and an innermost turn coil C2′ sequentially from the external surface toward the internal side of the main body 100. Meanwhile, although not shown, at least one intermediate turn coil may be disposed between the outermost turn coil C1′ and the innermost turn coil C2′.

An insulation film IF may be disposed along a surface of each of the plurality of turns of the coil 200. The insulation film IF is for protecting and insulating the plurality of turns of the coil 200, and may include a known insulating material such as parylene. Any insulating material may be used in the insulating film IF, and there is no particular limitation. For example, the insulating film IF may be a polyurethane resin, a polyester resin, an epoxy resin, or a polyamideimide resin. The insulating film IF may be formed by a method such as vapor deposition, but is not limited thereto.

A cross-sectional shape of the coil 200 will now be described in detail.

Referring to FIG. 2, a cross-sectional shape of the individual conductive wire of the coil 200 is a triangular in shape. The triangle is not limited to triangles in specific shapes, and may have various shapes such as an isosceles triangle or an equilateral triangle.

The cross-sectional shape of the conductive wire of the first portion 201 of the coil 200 and the cross-sectional shape of the conductive wire of the second portion 203 may be complementary.

For example, the conductive wire of the first portion 201 may be disposed so that one side of the triangle may face the sixth surface S6 of the main body 100, and the conductive wire of the second portion 203 may be disposed so that one side of the triangle may face the fifth surface S5 of the main body 100. Therefore, the triangular cross-section of the conductive wire of the first portion 201 and the inverted triangular cross-section of the conductive wire of the second portion 203 may be alternately arranged along the length direction (L-axis direction). Except for the outermost portion and the innermost portion of the coil 200, the conductive wire of the first portion 201 and the conductive wire of the second portion 203 may be in contact with each other on two sides, thereby achieving a stable structure. Therefore, in the manufacturing process of an inductor, when the sheet of magnetic material is pressed onto the coil 200, deformation or misalignment of the coil 200 may be prevented.

In contrast, if the cross-sectional shapes of the conductive wires of the first portion 201 and the second portion 203 of the coil 200 are rectangular and the first portion 201 and the second portion 203 are stacked in the thickness direction (T-axis direction), the conductive wire of the first portion 201 and the conductive wire of the second portion 203 may contact each other on one side. This structure is less stable than the case when the respective conductive wires with the triangular cross-sectional shape contact each other on two sides. As a result, there is a high probability that the coils are deformed or misaligned during the manufacturing process of an inductor.

The coil 200 may include a wound portion 205 and a lead-out portion 207.

The wound portion 205 is a portion where a conductive wire of the coil 200 comprises at least one turn.

The lead-out portion 207 may extend from respective ends of the wound portion 205 and may be exposed from the sixth surface S6 of the main body 100. For example, the lead-out portion 207 may be welded to the respective ends of the wound portion 205, and the cross-sectional shape of the lead-out portion 207 may be the same as or different from the cross-sectional shape of the conductive wire of the coil 200.

The lead-out portion 207 includes a first lead-out portion 208 and a second lead-out portion 209. The first lead-out portion 208 may extend from one end of the wound portion 205 and may be exposed from the sixth surface S6 of the main body 100, and the second lead-out portion 209 may extend from the other end of the wound portion 205 and may be exposed from the sixth surface S6 of the main body 100.

Meanwhile, the portions of the first lead-out portion 208 and the second lead-out portion 209 exposed from the sixth surface S6 of the main body 100 may be spaced apart from each other in the length direction (L-axis direction), but are not limited thereto.

The first lead-out portion 208 and the second lead-out portion 209 each extend from the wound portion 205. For example, the first lead-out portion 208 may extend from the rear surface 101B side of the base portion 101 through the front surface 101A toward the lower surface 101C, and may be connected to the first external electrode 300. The second lead-out portion 209 may extend from the rear surface 101B of the base portion 101 through the front surface 101A toward the lower surface 101C, and may be connected to the second external electrode 400. However, the present embodiment is not limited thereto, and the first and second lead-out portions may extend in various directions.

Meanwhile, an insulation film IF may be disposed on a portion other than the portion where the first lead-out portion 208 is connected to the first external electrode 300, and an insulation film IF may be disposed on a portion other than the portion where the second lead-out portion 209 is connected to the second external electrode 400.

The base portion 101 may be provided with a first groove 107 and a second groove 108.

The first groove 107 and the second groove 108 may be formed across the front surface 101A and the lower surface 101C of the base portion 101 on both sides in the length direction (L-axis direction). The first groove 107 and the second groove 108 may extend to the rear surface 101B of the base portion 101.

The first groove 107 and the second groove 108 may guide the first lead-out portion 208 and the second lead-out portion 209 of the coil 200. For example, the first lead-out portion 208 may extend along the first groove 107 and may be connected to the first external electrode 300, and the second lead-out portion 209 may extend along the second groove 108 and may be connected to the second external electrode 400. However, the present embodiment is not limited thereto, the first lead-out portion and the second lead-out portion may extend in various directions.

The first groove 107 and the second groove 108 may have a depth and width to accommodate the first lead-out portion 208 and the second lead-out portion 209, respectively. For example, the depths of the first groove 107 and the second groove 108 may be less than or equal to the thicknesses of the first lead-out portion 208 and the second lead-out portion 209, and the widths of the first groove 107 and the second groove 108 may be equal to or greater than the widths of the first lead-out portion 208 and the second lead-out portion 209.

However, the groove does necessarily have to be formed on the base portion, and the groove may not be present depending on the method of forming the base portion or the method for arranging the lead-out portion.

The cross-sectional shape of the first lead-out portion 208 and the second lead-out portion 209 along the length direction (L-axis direction) of the main body 100 may be rectangular, but is not limited to this, and may have various shapes such as a circle, an oval, or a triangle.

The first external electrode 300 and the second external electrode 400 are disposed outside the main body 100 and are electrically connected to the coil 200.

The first external electrode 300 is disposed on the sixth surface S6 of the main body 100, and the first lead-out portion 208 of the coil 200 is exposed from the sixth surface S6 of the main body 100 and is connected to the first external electrode 300.

The second external electrode 400 is disposed on the sixth surface S6 of the main body 100, and the second lead-out portion 209 of the coil 200 is exposed from the sixth surface S6 of the main body 100 and is connected to the second external electrode 400.

The first external electrode 300 and the second external electrode 400 may comprise a conductive material such as copper (Cu), aluminum (Al), silver (Ag), tin (Sn), gold (Au), nickel (Ni), lead (Pb), chromium (Cr), titanium (Ti), an alloy thereof, or the like, but are not limited thereto.

The first external electrode 300 and the second external electrode 400 may include a plurality of metal layers formed by plating a conductive metal.

The first external electrode 300 may include a first metal layer 301, a second metal layer 302, and a third metal layer 303.

Referring to the left circle in FIG. 2, the first metal layer 301 may be a plating layer in contact with the first lead-out portion 208 of the coil 200 and the external surface of the main body 100, and may include copper (Cu). The second metal layer 302 may be a plating layer that covers the first metal layer 301, and may include nickel (Ni). The third metal layer 303 may be a plating layer that covers the second metal layer 302, and may include tin (Sn). However, the present embodiment is not limited to a three-layer structure, and a two-layer structure with only one plating layer added to the first metal layer 301 is also possible.

The second external electrode 400 may include a first metal layer 401, a second metal layer 402, and a third metal layer 403.

Referring to the right circle in FIG. 2, the first metal layer 401 may be a plating layer in contact with the second lead-out portion 209 of the coil 200 and the external side of the main body 100, and may include copper (Cu). The second metal layer 402 may be a plating layer that covers the first metal layer 401, and may include nickel (Ni). The third metal layer 403 may be a plating layer that covers the second metal layer 402, and may include tin (Sn). However, the present embodiment is not limited to a three-layer structure, and a two-layer structure with only one plating layer added to the first metal layer 401 is also possible.

As described above, the first external electrode 300 and the second external electrode 400 may include nickel (Ni), copper (Cu), palladium (Pd), gold (Au) or alloys thereof, and may include a plurality of plating layers. For example, the first external electrode 300 and the second external electrode 400 may be a combination of nickel (Ni) layer, copper (Cu) layer, nickel/copper (Ni/Cu) layer, palladium/nickel (Pd/Ni) layer, palladium/nickel/copper (Pd/Ni/Cu) layer, and copper/nickel/copper (Cu/Ni/Cu) layer.

In some embodiments, an outermost layer may include tin (Sn). A tin plating layer has a relatively low melting point, and thus may improve the ease of substrate mounting of the first external electrode 300 and the second external electrode 400.

Generally, the tin plating layer may be coupled to an electrode pad on a substrate through a solder including a tin (Sn)-copper (Cu)-silver (Ag) alloy paste. That is, the tin plating layer may melt and bond with the solder during a heat treatment (reflow) process.

Meanwhile, the first external electrode 300 and the second external electrode 400 may be wholly or partially embedded in the base portion 101, or may protrude in the thickness direction (T-axis direction) from the lower surface 101C of the base portion 101.

In the main body 100 of the coil electronic component 1000, an insulation layer 900 may be disposed in a region other than the region where the first external electrode 300 and the second external electrode 400 are disposed. Alternatively, an insulation layer may be present in regions between the portion where the first lead-out portion 208 of the coil 200 is exposed and the portion where the second lead-out portion 209 is exposed on the sixth surface S6 of the main body 100. In this case, the first external electrode 300 and the second external electrode 400 may cover a portion of the insulation layer.

As described above, the insulation layer 900 may be disposed on at least a portion of the first surface S1, the second surface S2, the third surface S3, the fourth surface S4, the fifth surface S5, and the sixth surface S6 of the main body 100 to prevent electrical short circuits between other electronic components and the external electrodes 300 and 400.

The insulation layer 900 may be utilized as a resist when forming the external electrodes 300 and 400 by an electroplating, but is not limited thereto.

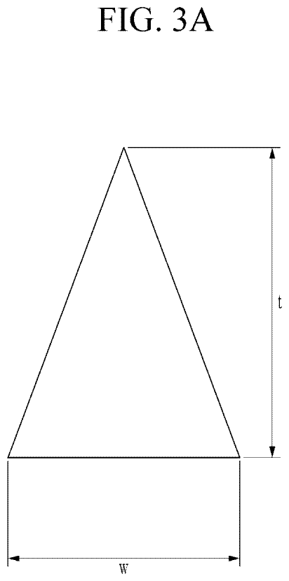

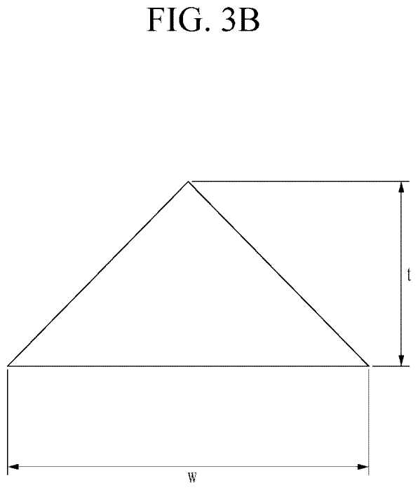

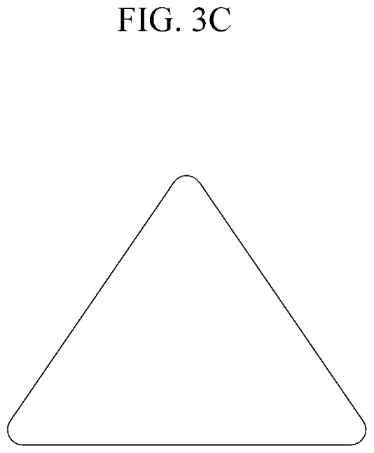

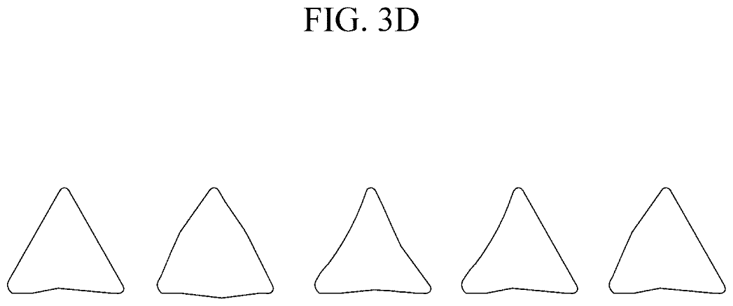

FIG. 3A, FIG. 3B, FIG. 3C, and FIG. 3D show various cross-sectional shapes of a coil, and the present embodiment includes all the shapes.

Referring to FIG. 3A, the coil has a cross-section has an isosceles triangular shape with a thickness (t) greater than a width (w).

Referring to FIG. 3B, the coil has a cross-section has an isosceles triangular shape with a thickness (t) smaller than a width (w).

Referring to FIG. 3C, the cross-section of the coil has an equilateral triangular shape with rounded vertices.

Referring to FIG. 3D, the cross-sections of the coil have a triangular shape with the vertices rounded and at least one side concave or convex.

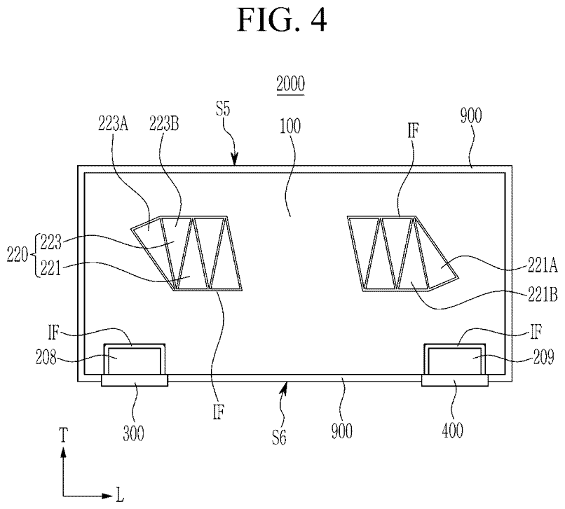

FIG. 4 shows a cross-sectional view of a coil electronic component according to another embodiment.

Referring to FIG. 4, the coil electronic component 2000 includes a main body 100, a coil 220, a first external electrode 300, and a second external electrode 400.

The coil 220 includes a first portion 221 and a second portion 223, and the second portion 223 is connected to the first portion 221. The cross-sectional shape of the conductive wire of the first portion 221 and the cross-sectional shape of the second portion 223 are both triangular in shape, and the first portion 221 and the second portion 223 are disposed complementary to each other.

For example, the conductive wire of the first portion 221 may be disposed such that one side of the triangle faces the sixth surface S6 of the main body 100, and the conductive wire of the second portion 223 may be disposed such that one side of the triangle faces the fifth surface S5 of the main body 100. Therefore, the triangular cross-section of the conductive wire of the first portion 201 and the inverted triangular cross-section of the conductive wire of the second portion 203 may be alternately arranged along the length direction (L-axis direction). Meanwhile, no conductive wires of the second portion 223 are disposed between the conductive wires 221A and 221B of the two outermost turns of the first portion 221 of the coil 220. However, the outermost conductive wire 221A may be inclined toward the inner conductive wire 221B so that the conductive wires 221A and 221B may contact each other to achieve a stable structure.

No conductive wires of the first portion 221 are disposed between the conductive wires 223A and 223B of the two outermost turns of the second portion 223 of the coil 220. However, the outermost conductive wire 223A may be inclined toward the inner conductive wire 223B so that the conductive wires 223A and 223B may contact each other to achieve a stable structure.

Except for the above-described components, the remaining components are the same as the components of the coil electronic component shown in FIG. 1, so a redundant description thereof will be omitted.

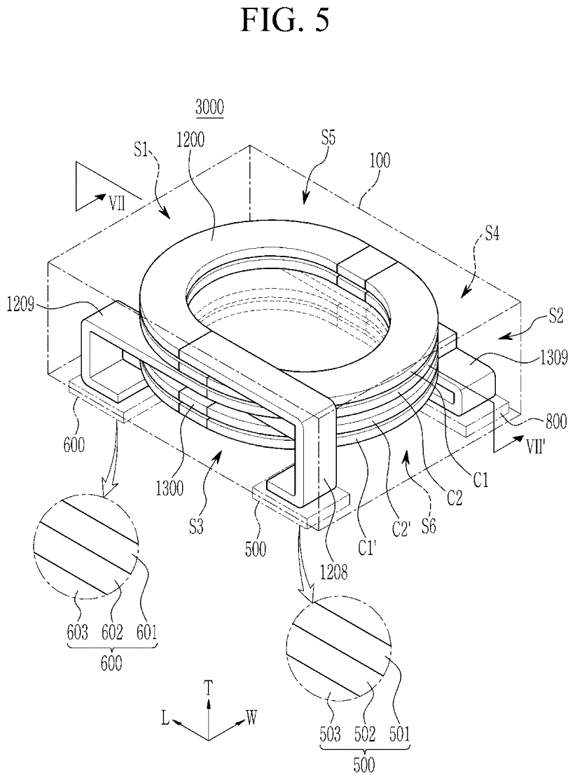

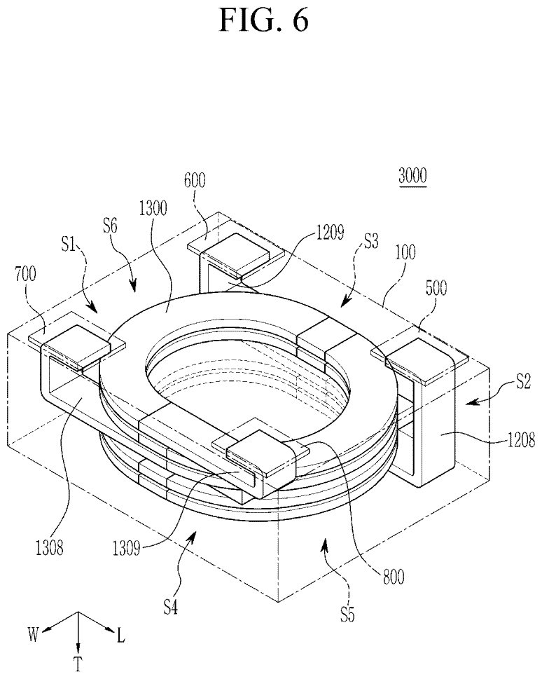

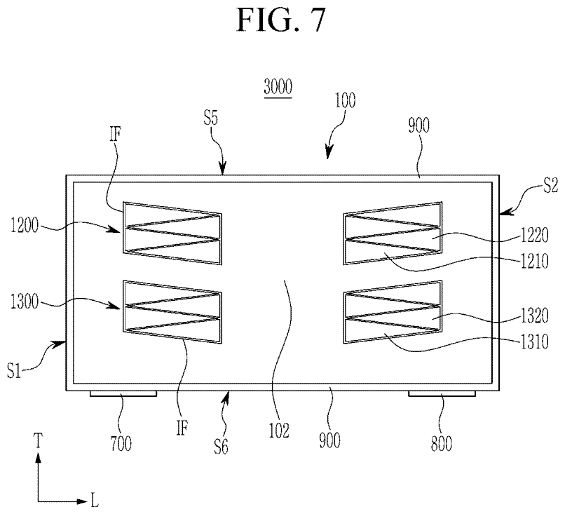

FIG. 5 shows a cross-sectional view of a coil electronic component according to another embodiment, FIG. 6 shows a bottom perspective view of the coil electronic component in FIG. 5, and FIG. 7 shows a cross-sectional view taken along line VII-VII′ in FIG. 5.

Referring to FIG. 5, FIG. 6 and FIG. 7, the coil electronic component 3000 may include a main body 100, a first coil 1200, a second coil 1300, a first external electrode 500, a second external electrode 600, a third external electrode 700, and a fourth external electrode 800.

The first coil 1200 and the second coil 1300 are disposed inside the main body 100, exhibiting the characteristics of the coil electronic component. For example, when the coil electronic component 1000 of the present embodiment is used as a power inductor, and a current is applied to the first coil 1200 and the second coil 1300, the coil 1200 may serve to stabilize power source of an electronic device by storing energy as a magnetic field.

The first coil 1200 and the second coil 1300 may be spaced from each other in the thickness direction (T-axis direction), and may be wound commonly around the core 102.

The first coil 1200 and the second coil 1300 may be magnetically coupled to each other to comprise a coupled inductor structure. The first coil 1200 and the second coil 1300 may have a plurality of turns, and the number of turns of the first coil 1200 and the number of turns of the second coil 1300 may be the same or different.

The first coil 1200 and the second coil 1300 may be edgewise coils.

For example, the first coil 1200 may have an outermost turn coil C1 and an innermost turn coil C2 sequentially from the fifth surface S5 to the sixth surface S6 of the coil electronic component 1000. Meanwhile, although not shown, at least one intermediate turn coil may be disposed between the outermost turn coil C1 and the innermost turn coil C2.

Similarly, the second coil 1300 may have an outermost turn coil C1′ and an innermost turn coil C2′ sequentially from the sixth surface S6 to the fifth surface S5 of the coil electronic component 1000. Meanwhile, although not shown, at least one intermediate turn coil may be disposed between the outermost turn coil C1′ and the innermost turn coil C2′.

An insulation film IF may be disposed along a surface of each of the plurality of turns of the first coil 1200 and the second coil 1300. The insulation film IF is for protecting and insulating the plurality of turns of the first coil 1200 and the second coil 1300, and may include a known insulating material such as parylene. Any insulating materials may be used in the insulating film IF, and there is no particular limitation. For example, the insulating film IF may be a polyurethane resin, a polyester resin, an epoxy resin, or a polyamideimide resin. The insulating film IF may be formed by a method such as vapor deposition, but is not limited thereto.

The first coil 1200 includes a first portion 1210 and a second portion 1220, and the second portion 1220 is connected to the first portion 1210. The second coil 1300 includes a first portion 1310 and a second portion 1320, and the second portion 1320 is connected to the first portion 1310.

The cross-sectional shapes of the individual conductive wires of the first coil 1200 and the second coil 1300 are triangular in shape. The triangle is not limited to triangles in specific shapes, and may have various shapes such as an isosceles triangle or an equilateral triangle.

The cross-sectional shape of the conductive wire of the first portion 1210 of the first coil 1200 and the cross-sectional shape of the conductive wire of the second portion 1220 may be complementary.

For example, the conductive wire of the first portion 1210 is disposed so that one side of the triangle may face the core 102, and the conductive wire of the second portion 1220 is dispose so that one side of the triangle may face the outer surface (first surface S1 or second surface S2) of the main body 100. Therefore, the triangular shape of the conductive wire of the first portion 1210 and the inverted triangular shape of the cross-section of the conductive wire of the second portion 1220 may be alternately arranged along the thickness direction (T-axis direction). Except for the outermost portion and the innermost portion of the first coil 1200, the conductive wire of the first portion 1210 and the conductive wire of the second portion 1220 may be in contact with each other on two sides, thereby achieving a stable structure. In particular, the first portion 1210 and the second portion 1220 may be strongly brought into contact during the winding process.

The conductive wire of the first portion 1310 of the second coil 1300 may be disposed so that one side of the triangle may face the core 102, and the conductive wire of the second portion 1320 may be disposed so that one side of the triangle may face the outer surface (the first surface S1 or the second surface S2) of the main body 100. Therefore, the triangular cross-section of the conductive wire of the first portion 1310 and the inverted triangular cross-section of the conductive wire of the second portion 1320 may be alternately arranged along the thickness direction (T-axis direction). Except for the outermost portion and the innermost portion of the second coil 1300, the conductive wire of the first portion 1310 and the conductive wire of the second portion 1320 may be in contact with each other on two sides, thereby achieving a stable structure. In particular, the first portion 1310 and the second portion 1320 may be strongly brought into contact during the winding process.

The first external electrode 500 and second external electrode 600 are disposed outside the main body 100 and are electrically connected to the first coil 1200.

The first external electrode 500 is disposed on the sixth surface S6 of the main body 100, and a first lead-out portion 1208 of the first coil 1200 is exposed from the sixth surface S6 of the main body 100 and is connected to the first external electrode 500.

The second external electrode 600 is disposed on the sixth surface S6 of the main body 100, and a second lead-out portion 1209 of the first coil 1200 is exposed from the sixth surface S6 of the main body 100 and is connected to the second external electrode 600.

The third external electrode 700 and fourth external electrode 800 are disposed outside the main body 100 and are electrically connected to the second coil 1300.

The third external electrode 700 is disposed on the sixth surface S6 of the main body 100, and a first lead-out portion 1308 of the second coil 1300 is exposed from the sixth surface S6 of the main body 100 and is connected to the third external electrode 700.

The fourth external electrode 800 is disposed on the sixth surface S6 of the main body 100, and a second lead-out portion 1309 of the second coil 1300 is exposed from the sixth surface S6 of the main body 100 and is connected to the fourth external electrode 800.

Referring to the right circle in FIG. 5, the first external electrode 500 may include a first metal layer 501, a second metal layer 502, and a third metal layer 503.

The first metal layer 501 may be a plating layer in contact with the first lead-out portion 1208 of the first coil 1200 and an external surface of the main body 100, and may include copper (Cu). The second metal layer 502 may be a plating layer that covers the first metal layer 501, and may include nickel (Ni). The third metal layer 503 may be a plating layer that covers the second metal layer 502, and may include tin (Sn). However, the present embodiment is not limited to such a three-layer structure, and a two-layer structure with only one plating layer added to the first metal layer 501 is also possible.

Referring to the left circle in FIG. 5, the second external electrode 600 may include a first metal layer 601, a second metal layer 602, and a third metal layer 603.

The first metal layer 601 may be a plating layer in contact with the second lead-out portion 1209 of the first coil 1200 and an external side of the main body 100, and may include copper (Cu). The second metal layer 602 may be a plating layer that covers the first metal layer 601, and may include nickel (Ni). The third metal layer 603 may be a plating layer that covers the second metal layer 602, and may include tin (Sn). However, the present embodiment is not limited to such a three-layer structure, and a two-layer structure with only one plating layer added to the first metal layer 601 is also possible.

As described above, the first external electrode 500 and the second external electrode 600 may include nickel (Ni), copper (Cu), palladium (Pd), gold (Au), or an alloy thereof, and may include a plurality of plating layers. For example, the first external electrode 500 and the second external electrode 600 may be a combination of nickel (Ni) layer, copper (Cu) layer, nickel/copper (Ni/Cu) layer, palladium/nickel (Pd/Ni) layer, palladium/nickel/copper (Pd/Ni/Cu) layer, and copper/nickel/copper (Cu/Ni/Cu) layer.

In some embodiments, an outermost layer may include tin (Sn). A tin plating layer has a relatively low melting point, and thus may improve the ease of substrate mounting of the first external electrode 500 and the second external electrode 600.

Generally, the tin plating layer may be coupled to an electrode pad on a substrate through a solder including a tin (Sn)-copper (Cu)-silver (Ag) alloy paste. That is, the tin plating layer may melt and bond with the solder during a heat treatment (reflow) process.

The structures and components of the third external electrode 700 and the fourth external electrode 800 are the same as those of the first external electrode 500 and the second external electrode 600 described above, so a redundant description thereof will be omitted.

In the main body 100 of the coil electronic component 3000 according to the present embodiment, an insulation layer 900 may be disposed in a region other than the region where the first external electrode 500, the second external electrode 600, the third external electrode 700, and the fourth external electrode 800 are disposed. Alternatively, an insulation layer may be present in regions between the portion where the first lead-out portion 1208 of the first coil 1200 is exposed, the portion where the second lead-out portion 1209 of the first coil 1200 is exposed, the portion where the first lead-out portion 1308 of the second coil 1300 is exposed, and the portion where the second lead-out portion 1309 of the second coil 1300 is exposed on the sixth surface S6 of the main body 100. In this case, the first external electrode 500, the second external electrode 600, the third external electrode 700, and the fourth external electrode 800 may cover a portion of the insulation layer.

As described above, the insulation layer 900 may be disposed on at least a portion of the first surface S1, the second surface S2, the third surface S3, the fourth surface S4, the fifth surface S5, and the sixth surface S6 of the main body 100 to prevent electrical short circuits between other electronic components and the external electrodes 500, 600, 700, and 800.

The insulation layer 900 may be utilized as a resist when forming the external electrodes 500, 600, 700, 800 by an electroplating, but is not limited thereto.

Except for the above-described components, the remaining components are the same as or correspond to those of the coil electronic component shown in FIG. 1, so a redundant description thereof will be omitted.

While the disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A coil electronic component comprising:
a main body including a first surface and a second surface facing each other, and including a magnetic material;
a coil including a first lead-out portion, a second lead-out portion, and at least one turn of a conductive wire, wherein a cross-sectional shape of the conductive wire includes a triangular shape, and at least a portion of the coil is embedded in the main body;
a first external electrode connected to the first lead-out portion; and
a second external electrode connected to the second lead-out portion.

2. The coil electronic component of claim 1, wherein
the coil includes a first portion including the at least one turn of the conductive wire, and a second portion connected to the first portion and including the at least one turn of the conductive wire,
the conductive wire in the first portion is disposed such that one side of a triangular cross-section of the conductive wire in the first portion faces the first surface, and
the conductive wire in the second portion is disposed such that one side of the triangular cross-section of the conductive wire in the second portion faces the second surface.

3. The coil electronic component of claim 2, wherein
the triangular cross-section of the conductive wire in the first portion and the triangular cross-section of the conductive wire in the second portion are alternately disposed such that the triangular cross-section of the conductive wire in the second portion is inverted relative to the triangular cross-section of the conductive wire in the first portion.

4. The coil electronic component of claim 3, wherein
each of two outermost turns of the conductive wire in the first portion has the triangular cross-section, and each of two outermost turns of the conductive wire in the second portion has the triangular cross-section that is inverted relative to the triangular cross-section of the two outermost turns of the conductive wire in the first portion.

5. The coil electronic component of claim 1, wherein
the magnetic material includes metal magnetic particles, and
the metal magnetic particles include two or more types of powders with different compositions.

6. The coil electronic component of claim 5, wherein
the metal magnetic particles include iron (Fe).

7. The coil electronic component of claim 1, further comprising:
an insulation film on a surface of the conductive wire.

8. The coil electronic component of claim 1, further comprising:
an insulation layer on a surface of the main body except for a portion where the first lead-out portion is connected to the first external electrode and a portion where the second lead-out portion is connected to the second external electrode.

9. A coil electronic component comprising:
a main body including a magnetic material;
a first coil including at least one turn of a first conductive wire, at least a portion of the first coil being embedded in the main body; and
a second coil spaced apart from the first coil, including at least one turn of a second conductive wire, at least a portion of the second coil being embedded in the main body,
wherein a cross-sectional shape of the first conductive wire includes a triangular shape and a cross-sectional shape of the second conductive wire includes a triangular shape.

10. The coil electronic component of claim 9, wherein
the first coil and the second coil are edgewise coils.

11. The coil electronic component of claim 10, wherein
the main body includes a core around which the first coil and the second coil are wound in common.

12. The coil electronic component of claim 11, wherein
the first coil includes a first portion including the at least one turn of the first conductive wire and a second portion connected to the first portion and including the at least one turn of the first conductive wire,
the first conductive wire in the first portion is disposed such that one side of a triangular cross-section of the first conductive wire in the first portion faces the core, and
the first conductive wire in the second portion is disposed such that one side of the triangular cross-section of the first conductive wire in the second portion faces an external surface of the main body.

13. The coil electronic component of claim 11, wherein
the second coil includes a third portion including the at least one turn of the second conductive wire and a fourth portion connected to the third portion and including the at least one turn of the second conductive wire,
the second conductive wire in the third portion is disposed such that one side of a triangular cross-section of the second conductive wire in the third portion faces the core, and
the second conductive wire in the fourth portion is disposed such that one side of the triangular cross-section of the second conductive wire in the fourth portion faces an external surface of the main body.

14. The coil electronic component of claim 9, wherein
a number of turns of the first coil and a number of turns of the second coil are the same.

15. The coil electronic component of claim 9, wherein
a number of turns of the first coil and a number of turns of the second coil are different.

16. A coil electronic component comprising:
a main body including a magnetic material; and
at least one coil including a conductive wire having a triangular cross-section, the at least one coil comprises a first portion including at least one turn of the conductive wire, and a second portion connected to the first portion and including at least one turn of the conductive wire,
wherein the triangular cross-section of the conductive wire in the first portion and the triangular cross-section of the conductive wire in the second portion are alternately disposed,
wherein the triangular cross-section of the conductive wire in the second portion is inverted relative to the triangular cross-section of the conductive wire in the first portion, and
wherein at least a portion of the coil is embedded in the main body.

17. The coil electronic component of claim 16, further comprising:
a first external electrode; and
a second external electrode,
wherein the at least one coil further comprises:
a first lead-out portion connected to the first external electrode, and
a second lead-out portion connected to the second external electrode.

18. The coil electronic component of claim 16, wherein
the at least one coil includes a first coil and a second coil, and the first coil and the second coil are edgewise coils.
